(19) United States
(12) Patent Application Publication
(10) Pub. No.: US 2026/0285003 A1
(43) Pub. Date: Sep. 24, 2026

(54) INTERLAYER FRAME FOR ENCAPSULATING FUNCTIONAL FILMS

(71) Applicant: Solutia Inc., St. Louis, MO (US)

(72) Inventors: Ingo Kramer, Herzogenrath (DE); Stijn Simonne Paul Van de Vyver, Ghent (BE)

(73) Assignee: Solutia Inc., St. Louis, MO (US)

(21) Appl. No.: 19/477,181

(22) PCT Filed: Apr. 23, 2024
(86) PCT No.: PCT/US2024/025748

§ 371 Date: Oct. 21, 2025

Related U.S. Application Data
(60) Provisional application No. 63/498,643, filed on Apr. 27, 2023.

(51) Int. Cl. B32B 3/04; B32B 17/10; B32B 38/00; B32B 38/10

(52) U.S. Cl. CPC B32B 3/04; B32B 17/10018; B32B 17/10293; B32B 17/10504; B32B 17/10513; B32B 17/10532; B32B 38/0004; B32B 38/10; B32B 2305/55; B32B 2307/7376; B32B 2329/06

(57) ABSTRACT

Methods are disclosed herein for constructing a functional interlayer stack, comprising: a) cutting two L-shaped pieces from corners of a bulk sheet of interlayer material, leaving a cut sheet; b) optionally trimming one or more of the two L-shaped pieces or the cut sheet; c) joining the L-shaped pieces to form a rectangular frame that defines a rectangular opening; d) placing the rectangular frame around a functional material to obtain a framed functional sheet; and e) covering the framed functional sheet with a cut sheet to form the functional interlayer stack, wherein the cut sheet of step e) is the same sheet as, or is a different sheet from, the cut sheet of step a).

### FIELD OF THE INVENTION

The present invention is generally directed to interlayers for encapsulating functional films.

### BACKGROUND OF THE INVENTION

The present invention relates to methods for efficiently reducing the scrap or process waste in the encapsulation process of functional films, for example switchable films. Smart glass or switchable glazing is manufactured by adding a switchable film to a laminate. The most common switchable films are based on polymer dispersed liquid crystals (PDLC), suspended particle devices (SPD), or electrochromic (EC) devices, photochromic devices, or photochromic/electrochromic devices. To bond to glass, the switchable films are confined between thermoplastic interlayer films such as plasticized polyvinyl butyral (PVB), ethyl vinyl acetate (EVA), or thermoplastic polyurethane (TPU).

Typically, these switchable films are cut a little smaller than the total area of the laminate so that there is a border of glass and interlayer to protect the edges of the switchable film (U.S. Pat. No. 8,995,039). One of the issues is that the absence of switchable film at the boundary of the laminate can cause optical distortion. To compensate for this thickness imbalance, the switchable films are framed by interlayer frames.

This “picture frame” design is, for example, described in U.S. Pat. No. 10,596,787. These interlayer frames are, for example, cut from 0.5-mm-thick PVB sheets such that the switchable film can be placed within the frame, while the offcuts from the middle of each sheet are currently treated as waste (FIG. 1). The switchable film and the interlayer frame are then sandwiched between interlayer films and laminated between glass panes.

Accordingly, what is needed in the art is an improved way to prepare interlayer frames that reduces scrap or process waste.

### SUMMARY OF THE INVENTION

In one aspect, the present invention relates to methods of constructing functional interlayer stacks, that include the steps of: a) cutting two L-shaped pieces from corners of a bulk sheet of interlayer material, leaving a cut sheet; b) optionally trimming one or more of the two L-shaped pieces or the cut sheet; c) joining the L-shaped pieces to form a rectangular frame that defines a rectangular opening; d) placing the rectangular frame around a functional material to obtain a framed functional sheet; and e) covering the framed functional sheet with a cut sheet to form the functional interlayer stack which is a multilayer stack. According to the invention, the cut sheet of step e) may be the same sheet as, or a different sheet from, the cut sheet of step a).

Further aspects of the invention are as disclosed and claimed herein.

### BRIEF DESCRIPTION OF THE DRAWINGS

FIG. 1 depicts a prior art method of cutting an interlayer frame from a bulk sheet of interlayer material which results in a great deal of waste.

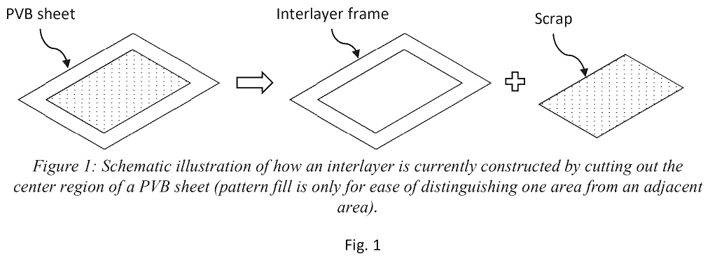

FIG. 2 depicts an embodiment of the present invention in which L-shaped pieces may be cut from a bulk or oversize interlayer sheet and joined together to form a rectangular frame for a functional sheet. The remainder of the cut sheet may be used as a top layer to from a functional stack.

### DETAILED DESCRIPTION

In one embodiment, the invention relates to methods of constructing a functional interlayer stack, comprising the steps of: a) cutting two L-shaped pieces from corners of a bulk sheet of interlayer material, leaving a cut sheet; b) optionally trimming one or more of the two L-shaped pieces or the cut sheet; c) joining the L-shaped pieces to form a rectangular frame that defines a rectangular opening; d) placing the rectangular frame around a functional material to obtain a framed functional sheet; and e) covering the framed functional sheet with a cut sheet to form the functional interlayer stack, which is thus a multilayer interlayer provided with the referenced functionality. According to the invention, the cut sheet of step e) may be the same sheet as, or may be a different sheet from, the cut sheet of step a).

In an embodiment, a variety of functional materials may be used. Thus, the functional material may comprise a photopolymer material, a conductive material, a solar-reflective material, a polymer-dispersed liquid crystal material, a suspended particle material, an electrochromic material, a photochromic material, an electrochromic/photochromic material, and the like.

In an embodiment according to any of the previous embodiments, the cut sheet of step e) may be the same sheet as the cut sheet of step a).

In an embodiment according to any of the previous embodiments, the cut sheet of step e) may be a different sheet from the cut sheet of step a).

In an embodiment according to any of the previous embodiments, the interlayer material may be a viscoelastic polymer.

In an embodiment according to any of the previous embodiments, the viscoelastic polymer may comprise one or more of a polyvinyl acetal such as a butyral, a thermoplastic polyurethane, or an ethylene vinyl acetate.

In an embodiment according to any of the previous embodiments, the cut sheet of step a) and the cut sheet of step e) comprise polyvinyl butyral having a thickness, for example, from about 0.1 mm to 1.0 mm.

In an embodiment according to any of the previous embodiments, the cut sheet of step a) and the cut sheet of step e) comprise polyvinyl butyral having a thickness, for example, from about 0.2 mm to 0.8 mm.

In an embodiment according to any of the previous embodiments, the inventions may further comprise covering the framed switchable sheet with a further cut sheet on a side opposite the cut sheet of step e). In this aspect, the stack is of course a multilayer interlayer, and may be considered a trilayer, with the framed switchable sheet having a cut sheet on either side thereof.

In an embodiment according to any of the previous embodiments, the inventions may further comprise placing a rigid substrate on either side of the functional interlayer stack to form a functional laminate.

We have discovered, according to the invention, a novel approach of constructing interlayer frames that reduces scrap or process waste in the encapsulation process of functional films such as functional films such as switchable films, photopolymer films, conductive films, solar reflective films, and the like. The present invention thus relates to a method for efficiently reducing the scrap or process waste in the encapsulation process of functional films such as switchable films.

According to the invention, functional laminates such as switchable glazings are manufactured by adding a functional film to a laminate. The most common switchable films are based on polymer dispersed liquid crystals (PDLC), suspended particle devices (SPD), or electrochromic (EC) devices. To bond to glass, the switchable films may be confined between thermoplastic interlayer films such as plasticized polyvinyl butyral (PVB), ethyl vinyl acetate (EVA), or thermoplastic polyurethane (TPU).

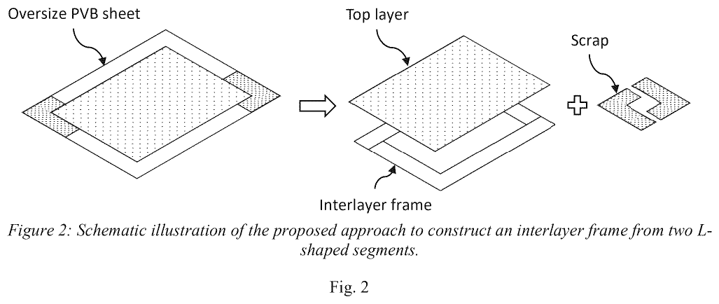

The present invention provides a novel approach to the design of interlayer frames for use in functionalities such as switchable glazing. According to the invention, the interlayer frames are made of two L-shaped segments that are cut from an oversize PVB sheet (FIG. 2). The two L-shaped sections are then welded or soldered together into a single interlayer frame, while the middle section of the oversize PVB sheet can be used as a top or bottom layer to laminate the switchable film to the glass. The approach of constructing the interlayer frame from L-shaped segments and reducing the scrap to the absolute minimum is non-obvious to those skilled in the art in that it resides in a unique approach that has not been considered or practiced to date.

It is understood that while particularly effective for switchable films, this approach can be used for any functional film (including, for example, photopolymer films, conductive films, or solar reflective films), regardless of the functionality it brings to the laminate. There are also many approaches according to the invention to welding the junctions between the preformed L-shaped PVB sections. Examples are hot air welding or ultrasonic welding (see e.g. U.S. Patent PubIn. No. US20200278540A1).

In one aspect, then, the invention relates to methods of constructing functional interlayer stacks. A wide variety of functionalities may thus be encompassed by the invention. In various embodiments, the functional material may comprise one or more of: functional material may comprise a photopolymer material, a conductive material, a solar-reflective material, a polymer-dispersed liquid crystal material, a suspended particle material, an electrochromic material, a photochromic material, or an electrochromic/photochromic material, or a holographic optical element. Other suitable functionalities include photovoltaics, transparent displays such as head-up displays, signs, or roofing, and the like.

According to the invention, two L-shaped pieces may be cut from corners of a bulk sheet of interlayer material, leaving a cut sheet. The L-shaped pieces will be cut so that they are suitable to form a rectangular frame, after any optional trimming that may be needed. The L-shaped pieces will be roughly defined by having an angular shape of roughly 90 degrees, each thus being capable of forming two sides of a rectangular frame once joined together.

The bulk sheets of interlayer material may be selected from a variety of materials and will be of a size suitable for both the L-shaped pieces and the cut sheets of a suitable size to be cut from them and used, for example, as a top and/or bottom layer.

Depending on the intended use, in one aspect, the bulk sheet may be approximately 140 cm by 180 cm in size, or from 120 to 160 or from 130 to 150 cm when used to form a windscreen/roof laminate. In another aspect, for example in the case of a conventional sunroof, the bulk sheet may be approximately 80 cm by 100 cm in size, or from 150 to 180 or from 100 to 150, for example.

Either or both of the two L-shaped pieces, as well as the cut sheet, may be further trimmed as needed or desired prior to use.

Thus, according to the invention, the bulk sheet of interlayer material may be selected from a variety of materials, and especially viscoelastic materials. The viscoelastic material may be a polyvinyl acetal, such as polyvinyl butyral. As noted, the L-shaped pieces which form the rectangular frame, may be the same or different than the cut sheets, which may be considered outer layers which may be contacted with rigid substrates to form a functional laminate. If the material of the L-shaped pieces is different than the material for the cut sheets, then naturally different bulk sheets will be needed.

Embodiments of the present invention are thus directed to multiple layer panels and methods of making multiple layer panels. Generally, multiple layer laminates are comprised of two sheets of glass, or other applicable substrates, with a polymer interlayer sheet or sheets sandwiched there-between. Multiple layer panels are generally produced by placing at least one polymer interlayer sheet between two substrates to create an assembly. As noted, the multilayered interlayer may be configured as a trilayer interlayer having three individual polymer interlayer sheets, including a core layer and two skin layers positioned on either side of the core layer.

In some embodiments, the interlayer (e.g., the core layer and the skin layers) will have a generally constant or uniform thickness about the length of the interlayer. However, in alternative embodiments, the interlayer may have at least one region of non-uniform thickness. For example, the interlayer, comprised of the core layer and skin layers, may be wedge-shaped, such that the thickness of the interlayer changes (e.g., linearly or non-linearly) about the length of the interlayer. In some such embodiments, the thickness of the interlayer may change due to a thickness change in the core layer (i.e., with the skin layers having a generally constant thickness). Alternatively, the thickness of the interlayer may change due to a thickness change in the skin layers (i.e., with the core layer having a generally constant thickness). In further alternatives, the thickness of the interlayer may change due to a thickness change in both the core layer and the skin layers.

In order to facilitate a more comprehensive understanding of the interlayers and multiple layer panels disclosed herein, the meaning of certain terms, as used in this application, will be defined.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises a polymer resin. The term “resin,” as utilized herein refers to the polymeric component (e.g., PVB) removed from the processes, such as those discussed more fully below. Generally, plasticizer, such as those discussed more fully below, is added to the resins to result in a plasticized polymer. Additionally, as described below, resins may have other components in addition to the polymer and plasticizer including; e.g., acetates, salts and alcohols.

It should also be noted that while poly(vinyl butyral) (“PVB”) interlayers are often specifically discussed as the polymer resin of the polymer interlayers in this application, it should be understood that other thermoplastic interlayers besides PVB interlayers may be used. Contemplated polymers include, but are not limited to, polyurethane, polyvinyl chloride, poly(ethylene vinyl acetate) and combinations thereof. These polymers can be utilized alone, or in combination with other polymers. Accordingly, it should be understood that when ranges, values and/or methods are given for a PVB interlayer in this application (e.g., plasticizer component percentages, thickness and characteristic-enhancing additives), those ranges, values and/or methods also apply, where applicable, to the other polymers and polymer blends disclosed herein or could be modified, as would be known to one of ordinary skill, to be applied to different materials.

As used herein, the term “molecular weight” refers to weight average molecular weight (Mw). The molecular weight of the PVB resin can be in the range of from about 50,000 to about 600,000, about 70,000 to about 450,000, or about 100,000 to about 425,000 Daltons.

The PVB resin may be produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026, the relevant disclosures of which are incorporated herein by reference.

While generally referred herein as “poly(vinyl acetal)” or “poly(vinyl butyral)”, the resins described herein may include residues of any suitable aldehyde, including, but not limited to, isobutyraldehyde, as previously discussed. In some embodiments, one or more poly(vinyl acetal) resin can include residues of at least one C₁ to C₁₀ aldehyde, or at least one C₄ to C: aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers function by embedding themselves between chains of polymers, spacing them apart (increasing the “free volume”) and thus significantly lowering the glass transition temperature (T_{g}) of the polymer resin, making the material softer. In this regard, the amount of plasticizer in the interlayer can be adjusted to affect the glass transition temperature (T_{g}). The glass transition temperature (T_{g}) is the temperature that marks the transition from the glassy state of the interlayer to the rubbery state. In general, higher amounts of plasticizer loading can result in lower T_{g}. In some embodiments, such as when the interlayer is an acoustic trilayer, the inner core layer (i.e., the soft layer) will have a glass transition temperature less than about 20° C., while the outer skin layers (e.g., the stiff layer) will have a glass transition temperature greater than about 25° C.

Contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phosphates and adipates, and mixtures and combinations thereof. 3-GEH is particularly preferred. Other examples of suitable plasticizers can include, but are not limited to, tetraethylene glycol di-(2-ethylhexanoate) (“4-GEH”), di(butoxyethyl) adipate, and bis(2-(2-butoxyethoxy)ethyl) adipate, dioctyl sebacate, nonylphenyl tetraethylene glycol, and mixtures thereof.

Other suitable plasticizers may include blends of two or more distinct plasticizers, including but not limited to those plasticizers described above. Still other suitable plasticizers, or blends of plasticizers, may be formed from aromatic groups, such polyadipates, epoxides, phthalates, terephthalates, benzoates, toluates, mellitates and other specialty plasticizers. Further examples include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, the plasticizer can be selected from the group consisting of dipropylene glycol dibenzoates, tripropylene glycol dibenzoates, and combinations thereof.

Generally, the plasticizer content of the polymer interlayers of this application are measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer. In some embodiments, the high rigidity interlayer comprises a layer having a plasticizer content of less than about 35 phr and less than about 30 phr.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, or about 50 to 70 phr.

When the interlayer includes a multiple layer interlayer, two or more polymer layers within the interlayer may have substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers. In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

In addition to plasticizers, it is also contemplated that adhesion control agents (“ACAs”) can also be added to the polymer resins to form polymer interlayers. ACAs generally function to alter and/or improve the adhesion of the interlayer to the glass panels when forming a laminated panel. Contemplated ACAs include, but are not limited to, magnesium carboxylates/salts. In addition, contemplated ACAs may also include those ACAs disclosed in U.S. Pat. No. 5,728,472, incorporated by reference herein in its entirety, such as residual sodium acetate, potassium acetate, and/or magnesium bis(2-ethyl butyrate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly(vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. In the process of hydrolyzing the poly(vinyl acetate), typically not all the acetate side groups are converted to hydroxyl groups. Further, the reaction with butyraldehyde typically will not result in all the hydroxyl groups being converted into acetal groups. Consequently, in any finished PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a wt. % basis per ASTM D-1396.

In various embodiments, the poly(vinyl butyral) resin comprises about 8 to about 35 wt. % (wt. %) residual hydroxyl groups calculated as PVOH, about 13 to about 30 wt. % residual hydroxyl groups calculated as PVOH, about 8 to about 22 wt. % residual hydroxyl groups calculated as PVOH, or about 15 to about 22 wt. % residual hydroxyl groups calculated as PVOH; and for some of the high rigidity interlayers disclosed herein, for one or more of the layers, the poly(vinyl butyral) resin comprises greater than about 19 wt. % residual hydroxyl groups calculated as PVOH, greater than about 20 wt. % residual hydroxyl groups calculated as PVOH, greater than about 20.4 wt. % residual hydroxyl groups calculated as PVOH, and greater than about 21 wt. % residual hydroxyl groups calculated as PVOH.

In some embodiments, the poly(vinyl butyral) resin used in at least one polymer layer of an interlayer may include a poly(vinyl butyral) resin that has a residual hydroxyl content of at least about 18, at least about 18.5, at least about 18.7, at least about 19, at least about 19.5, at least about 20, at least about 20.5, at least about 21, at least about 21.5, at least about 22, at least about 22.5 wt. % and/or not more than about 30, not more than about 29, not more than about 28, not more than about 27, not more than about 26, not more than about 25, not more than about 24, not more than about 23, or not more than about 22 wt. %, measured as described above.

Additionally, one or more other polymer layers in the interlayers described herein may include another poly(vinyl butyral) resin that has a lower residual hydroxyl content. For example, in some embodiments, at least one polymer layer of the interlayer can include a poly(vinyl butyral) resin having a residual hydroxyl content of at least about 8, at least about 8.5, at least about 9, at least about 9.5, at least about 10, at least about 10.5, at least about 11, at least about 11.5, at least about 12, at least about 13 wt. % and/or not more than about 16, not more than about 15, not more than about 14, not more than about 13.5, not more than about 13, not more than about 12, or not more than about 11.5 wt. %, measured as described above.

When the interlayer includes two or more polymer layers, the layers may include poly(vinyl butyral) resins that have substantially the same residual hydroxyl content, or the residual hydroxyl contents of the poly(vinyl butyral) resins in each layer may differ from each other. When two or more layers include poly(vinyl butyral) resins having substantially the same residual hydroxyl content, the difference between the residual hydroxyl contents of the poly(vinyl butyral) resins in each layer may be less than about 2, less than about 1, or less than about 0.5 wt. %. As used herein, the terms “weight percent different” and “the difference between . . . is at least . . . weight percent” refer to a difference between two given weight percentages, calculated by subtracting one number from the other. For example, a poly(vinyl acetal) resin having a residual hydroxyl content of 12 wt. % has a residual hydroxyl content that is 2 wt. % different than a poly(vinyl acetal) resin having a residual hydroxyl content of 14 wt. % (14 wt. %−12 wt. %=2 wt. %). As used herein, the term “different” can refer to a value that is higher than or lower than another value. Unless otherwise specified, all “differences” herein refer to the numerical value of the difference and not to the specific sign of the value due to the order in which the numbers were subtracted. Accordingly, unless noted otherwise, all “differences” herein refer to the absolute value of the difference between two numbers.

When two or more layers include poly(vinyl butyral) resins having different residual hydroxyl contents, the difference between the residual hydroxyl contents of the poly(vinyl butyral) resins can be at least about 2, at least about 3, at least about 4, at least about 5, at least about 6, at least about 7, at least about 8, at least about 9, at least about 10, at least about 12, at least about 15 wt. %, measured as described above.

The resin can also comprise less than 35 wt. % residual ester groups, less than 30 wt. %, less than 25 wt. %, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference). The residual acetate content of a resin may also be determined according to ASTM D-1396.

In some embodiments, as described above, one or more of the polymer layers of the interlayer may be formed from poly(vinyl acetal) resin. Such poly(vinyl acetal) resin may have a residual acetate content of at least about 1, at least about 3, at least about 5, at least about 7 wt. % and/or not more than about 15, not more than about 12, not more than about 10, not more than about 8 wt. %, measured as described above. When the interlayer comprises a multiple layer interlayer, two or more polymer layers can include resins having substantially the same residual acetate content, or one or more resins in various layers can have substantially different acetate contents. When the residual acetate contents of two or more resins are substantially the same, the difference in the residual acetate contents may be, for example, less than about 3, less than about 2, less than about 1, or less than about 0.5 wt. %. In some embodiments, the difference in residual acetate content between two or more poly(vinyl butyral) resins in a multiple layer interlayer can be at least about 3, at least about 5, at least about 8, at least about 15, at least about 20, or at least about 30 wt. %. When such resins are utilized in a multiple layer interlayer, the resins having different residual acetate contents may be located in adjacent polymer layers. When the multiple layer interlayer is a three-layer interlayer including a pair of outer “skin” layers surrounding, or sandwiching, an inner “core” layer, for example, the core layer may include a resin having higher or lower residual acetate content. At the same time, the resin in the inner core layer can have a residual hydroxyl content that is higher or lower than the residual hydroxyl content of the outer skin layer and fall within one or more of the ranges provided previously.

Poly(vinyl acetal) resins having higher or lower residual hydroxyl contents and/or residual acetate contents may also, when combined with at least one plasticizer, ultimately include different amounts of plasticizer. As a result, layers or domains formed of first and second poly(vinyl acetal) resins having different compositions may also have different properties within a single polymer layer or interlayer. Notably, for a given type of plasticizer, the compatibility of the plasticizer in the polymer is largely determined by the hydroxyl content of the polymer. Polymers with a greater residual hydroxyl content are typically correlated with reduced plasticizer compatibility or capacity. Conversely, polymers with a lower residual hydroxyl content typically will result in increased plasticizer compatibility or capacity. As a result, poly(vinyl acetal) resins with higher residual hydroxyl contents tend to be less plasticized and exhibit higher stiffness than similar resins having lower residual hydroxyl contents. Conversely, poly(vinyl acetal) resins having lower residual hydroxyl contents may tend to, when plasticized with a given plasticizer, incorporate higher amounts of plasticizer, which may result in a softer polymer layer that exhibits a lower glass transition temperature than a similar resin having a higher residual hydroxyl content. Depending on the specific resin and plasticizer, these trends could be reversed.

When two poly(vinyl acetal) resins having different levels of residual hydroxyl content are blended with a plasticizer, the plasticizer may partition between the polymer layers or domains, such that more plasticizer can be present in the layer or domain having the lower residual hydroxyl content and less plasticizer may be present in the layer or domain having the higher residual hydroxyl content. Ultimately, a state of equilibrium is achieved between the two resins. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content within multilayered interlayers. Such a correlation also helps to stably maintain the difference in plasticizer content between two or more resins when the plasticizer would otherwise migrate between the resins.

As a result of the migration of plasticizer within an interlayer, the glass transition temperatures of one or more polymer layers may be different when measured alone or as part of a multiple layer interlayer. In some embodiments, the interlayer can include at least one polymer layer having a glass transition temperature, outside of an interlayer, of at least about 33, at least about 34, at least about 35, at least about 36, at least about 37, at least about 38, at least about 39, at least about 40, at least about 41, at least about 42, at least about 43, at least about 44, at least about 45, or at least about 46° C. In some embodiments, the same layer may have a glass transition temperature within the polymer layer of at least about 34, at least about 35, at least about 36, at least about 37, at least about 38, at least about 39, at least about 40, at least about 41, at least about 42, at least about 43, at least about 44, at least about 45, at least about 46, or at least about 47° C.

In the same or other embodiments, at least one other polymer layer of the multiple layer interlayer can have a glass transition temperature less than 30° C. and may, for example, have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, not more than about 0, not more than about −1, not more than about −2° C., or not more than about −5° C., measured when the interlayer is not part of an interlayer. The same polymer layer may have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, or not more than about 0° C., when measured outside of the interlayer.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35, at least about 40, or at least about 45° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)//(soft)//(stiff) creates a multilayered interlayer that is easily handled, can be used in conventional lamination methods and that can be constructed with layers that are relatively thin and light. The soft layer is generally characterized by a lower residual hydroxyl content (e.g., less than or equal to 16 wt. %, less than or equal to 15 wt. %, or less than or equal to 12 wt. % or any of the ranges disclosed above), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through extrusion and/or co-extrusion processes. The final multiple layer glass panel laminate of the present disclosure are formed using processes known in the art.

In the extrusion process, thermoplastic resin and plasticizers, including any of those resins and plasticizers described above, are generally pre-mixed and fed into an extruder device. Additives such as colorants and UV inhibitors (in liquid, powder, or pellet form) may be used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material and plasticizers, including any of those resins, plasticizers, and other additives described above, are further mixed and melted, resulting in a melt that is generally uniform in temperature and composition. Embodiments of the present invention may provide for the melt temperature to be approximately 200° C. Once the melt reaches the end of the extruder device, the melt is propelled into the extruder die. The extruder die is the component of the extruder device which gives the final polymer interlayer sheet product its profile. The die will generally have an opening, defined by a lip, that is substantially greater in one dimension than in a perpendicular dimension. Generally, the die is designed such that the melt evenly flows from a cylindrical profile coming out of the die and into the product's end profile shape. A plurality of shapes can be imparted to the end polymer interlayer sheet by the die so long as a continuous profile is present. Generally, in its most basic sense, extrusion is a process used to create objects of a fixed cross-sectional profile. This is accomplished by pushing or drawing a material through a die of the desired cross-section for the end product.

In some embodiments, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. For example, the multiple layer interlayers of the present invention (e.g., in the form of a trilayer interlayer) may be preferably co-extruded using a multiple manifold co-extrusion device which includes a first die manifold, a second die manifold, and a third die manifold. The co-extrusion device may operate by simultaneously extruding polymer melts from each manifold through a die and out of an opening, where the multiple layer interlayer is extruded as a composite of three individual polymer layers. The polymer melts may flow through the die such that the core layer is positioned between the skin layers, to result in the manufacture of a trilayer interlayer with the core layer sandwiched between the skin layers. The die opening may include a pair of lips positioned on either side of the opening. Given the positional orientation of the polymer melts, the skin layers may come into contact with the lips. Regardless, the interlayer thickness can be varied by adjusting the distance between die lips located at the die opening.

The thickness of the multiple polymer layers leaving the extrusion die in the co-extrusion process can generally be controlled by adjustment of the relative speeds of the melt through the extrusion die and by the sizes of the individual die lips. According to some embodiments, the total thickness of the multiple layer interlayer can be at least about 13 mils, at least about 20, at least about 25, at least about 27, at least about 30, at least about 31 mils and/or not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, not more than about 9 mils. In some embodiments, each of the layers may have approximately the same thickness, while in other embodiments, one or more layers may have a different thickness than one or more other layers within the interlayer.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, or not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, or more of the individual resin layers may include at least one tapered zone. Tapered interlayers may be particularly useful in, for example, heads-up display (HUD) panels in automotive and aircraft applications.

Thus, in an embodiment according to any of the previous embodiments, the cut sheet of step a) and the cut sheet of step e) may comprise polyvinyl butyral having a thickness from about 0.1 mm to 1.0 mm.

In an embodiment according to any of the previous embodiments, the cut sheet of step a) and the cut sheet of step e) comprise polyvinyl butyral having a thickness from 0.2 mm to 0.8 mm.

According to the invention, the L-shaped pieces may be joined to form a rectangular frame that defines a rectangular opening. A variety of methods may be used to join the materials together. Methods of joining the L-shaped pieces together include heat welding, solvent welding, and the like. They may also be connected by form-fitting the pieces together such that they may be held together by friction.

According to the invention, the rectangular frame may then be placed around a functional material to obtain a framed functional sheet. This may also be described as placing the functional material within the rectangular frame, or within the rectangular opening defined by the frame.

According to the invention, the framed functional sheet may be covered with a cut sheet to form the functional interlayer stack. According to the invention, the cut sheet of step e) may be the same sheet as, or may be a different sheet from, the cut sheet of step a). Thus, the cut sheet of step e) may be the same sheet as the cut sheet of step a), or alternatively, the cut sheet of step e) may be a different sheet from the cut sheet of step a).

In an embodiment according to any of the previous embodiments, the inventions may further comprise covering the framed switchable sheet with a further cut sheet on a side opposite the cut sheet of step e). In this aspect, cut sheets may be used as both a top layer and a bottom layer for the framed switchable sheet.

In an embodiment according to any of the previous embodiments, the inventions may further comprise placing a rigid substrate on either side of the switchable interlayer stack to form a switchable laminate. A wide variety of rigid substrates may be used, and especially glass. Other rigid substrates may include polycarbonates, ethylene vinyl alcohol, and other thermoplastic polymers including thermoplastic ionomers.

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 diols”, is intended to specifically include and disclose C1, C2, C3, C4 and C5 diols.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition “comprising”, “containing”, “having” or “including” “an” ingredient or “a” polyester is intended to include other ingredients or other polyesters, respectively, in addition to the specifically identified ingredient or residue. Accordingly, the terms “containing”, “having” or “including” are intended to be synonymous and may be used interchangeably with the term “comprising”, meaning that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

While the composition of the present invention has been described above in detail with respect to two exemplary embodiments with two end-use utilities, it will be understood by the person of ordinary skill that the composition of the present invention may be utilized in a wide variety of end-use applications.

The following examples set forth suitable and/or preferred methods and results in accordance with the invention. It is to be understood, however, that these examples are provided by way of illustration, and nothing therein should be taken as a limitation upon the overall scope of the invention. All percentages are by weight unless otherwise specified.

### EXAMPLES

### Prophetic Example 1

In this prophetic example, an interlayer frame is formed from two L-shaped segments that are cut from an oversize PVB sheet (see FIG. 2). The two L-shaped sections are then welded or soldered together into a single interlayer frame, while the middle section of the oversize PVB sheet can be recovered and used as a top layer to laminate the switchable film to the glass. The approach of constructing the interlayer frame from L-shaped segments and reducing the scrap to the absolute minimum is non-obvious to those skilled in the art in that it resides in a unique approach that has not been considered or practiced to date.

### Prophetic Example 2

In this prophetic example, an interlayer frame is formed from two L-shaped segments that are cut from an oversize PVB sheet (see FIG. 2). The two L-shaped sections are then form-fitted together into a single interlayer frame (which joins the pieces together during lamination), while the middle section of the oversize PVB sheet is recovered and used as a top layer to laminate the switchable film to the glass. The approach of constructing the interlayer frame from L-shaped segments and reducing the scrap to the absolute minimum is non-obvious to those skilled in the art in that it resides in a unique approach that has not been considered or practiced to date.

1. A method of constructing a functional interlayer stack, comprising:
a) cutting two L-shaped pieces from corners of a bulk sheet of interlayer material, leaving a cut sheet;
b) optionally trimming one or more of the two L-shaped pieces or the cut sheet;
c) joining the L-shaped pieces to form a rectangular frame that defines a rectangular opening;
d) placing the rectangular frame around a functional material to obtain a framed functional sheet; and
e) covering the framed functional sheet with a cut sheet to form the functional interlayer stack, wherein the cut sheet of step e) is the same sheet as, or is a different sheet from, the cut sheet of step a).

2. The method of claim 1, wherein the functional material comprises one or more of: a photopolymer material, a conductive material, a solar-reflective material, a polymer-dispersed liquid crystal material, a suspended particle material, an electrochromic material, a photochromic material, or an electrochromic/photochromic material.

3. The method of claim 1, wherein the cut sheet of step e) is the same sheet as the cut sheet of step a).

4. The method of claim 1, wherein the cut sheet of step e) is a different sheet from the cut sheet of step a).

5. The method of claim 4, wherein the interlayer material is a viscoelastic polymer.

6. The method of claim 5, wherein the viscoelastic polymer comprises one or more of a polyvinyl acetal, a thermoplastic polyurethane, or an ethylene vinyl acetate.

7. The method of claim 6, wherein the cut sheet of step a) and the cut sheet of step e) comprise polyvinyl butyral having a thickness from about 0.1 mm to 1.0 mm.

8. The method of claim 7, wherein the cut sheet of step a) and the cut sheet of step e) comprise polyvinyl butyral having a thickness from about 0.2 mm to 0.8 mm.

9. The method of claim 8, further comprising covering the framed switchable sheet with a further cut sheet on a side opposite the cut sheet of step e).

10. The method of claim 9, further comprising placing a rigid substrate on either side of the switchable interlayer stack to form a functional laminate.

11. The method of claim 10, wherein the joining of the L-shaped pieces is accomplished by one or more of heat welding, solvent welding, or form-fitting the pieces together.
